(19) United States
(12) Patent Application Publication
(10) Pub. No.: US 2006/0140627 A1
(43) Pub. Date: Jun. 29, 2006

(54) Supervising system, supervising apparatus and supervising method of supervising optical transmission line

(75) Inventor: Ryu Yokoyama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/315,116

(22) Filed: Dec. 23, 2005

(30) Foreign Application Priority Data
Dec. 24, 2004 (JP) 373629/2004

(51) Int. Cl. H04B 10/08

(52) U.S. Cl. 398/30

(57) ABSTRACT

A supervising apparatus for supervising optical transmission lines includes a first optical transmission line which transmits a signal light, a first supervisory light, and a second supervisory light; a second optical transmission line disposed opposite the first optical transmission line; a first supervisory-light transfer unit which cuts off the signal light and the second supervisory light from among lights returned while transmitted in the first optical transmission line, and transfers the first supervisory light transmitted, to the second optical transmission line; and a second supervisory light transfer unit which cuts off the signal light and the first supervisory light from among lights transmitted in the first optical transmission line, and transfers the second supervisory light transmitted, to the second optical transmission line.

### BACKGROUND OF THE INVENTION

1. Field of the Invention

The present invention relates to a technique for supervising optical transmission lines, and more particularly to, a supervising system, a supervising apparatus and a supervising method of supervising optical transmission lines disposed opposite each other.

2. Description of Related Art

In optical fiber transmission line supervising systems of conventional art, optical line terminating equipment disposed in either side of the optical fiber transmission line supervises either one of the up-streaming or down-streaming optical fiber transmission line. Accordingly, in order to supervise both the optical fiber transmission lines, each said optical fiber transmission line must be supervised from the optical line terminating equipment disposed in both sides of the optical fiber transmission lines.

By contrast, there has been proposed a supervising system in which both the up-streaming/down-streaming optical fiber transmission lines can be supervised by one optical line terminating equipment disposed in either side (for example, U.S. Pat. No. 6,301,404 columns 9 to 11, FIGS. 7 to 10). FIG. 10 shows the configuration of an optical amplifying repeater proposed in the above invention. Optical fiber transmission lines 13a-1 and 13a-2 denote a down-streaming optical transmission line, and optical fiber transmission lines 13b-1 and 13b-2 denote an up-streaming optical transmission line.

An optical amplifying repeater 14 includes down-streaming/up-streaming optical amplifiers 16a and 16b, optical couplers 15a-1, 15a-2, 15b-l and 15b-2, optical fiber gratings (hereinafter referred to as FBG) 19a-1, 19a-2, 19b-1 and 19b-2, non-reflective ends 20a-1, 20a-2, 20b-1 and 20b-2, and optical bypasses 17 and 18. The optical couplers 15a-1 and 15b-1 are disposed in the input side of the optical amplifiers 16a and 16b, respectively; the optical couplers 15a-2 and 15b-2 are disposed in the output side of the optical amplifiers 16a and 16b, respectively. The FBGs, which are connected to the optical couplers, respectively, each reflect only a specific wavelength. The non-reflective ends prevent signal light passing through the FBG from being reflected toward the FBG side. The optical bypass 17 connects the optical coupler 15a-1 in down-streaming input-side and the optical coupler 15b-2 in up-streaming output-side; the optical bypass 18 connects the optical coupler 15a-2 in down-streaming output-side and the optical coupler 15b-1 in up-streaming input-side. The FBG 19b-l reflects only a wavelength of λsv1, and the FBG 19a-2 reflects only a wavelength of λsv2.

The operation of the above proposition will now be described. FIG. 11 shows how the down-streaming optical fiber transmission line 13a-2 disposed in the rear stage of the optical amplifying repeater 14 is supervised by supervisory signal light (hereinafter referred to as SV light) λsv1. FIG. 12 shows how the up-streaming optical fiber transmission line 13b-1 disposed in the front stage of the optical amplifying repeater 14 is supervised by SV light λsv2.

Referring to. FIG. 11, the SV light λsv1 is transmitted from optical line terminating equipment (not shown) disposed to the left of the drawing together with main signal lights λ1 to λm (m being an integer number of two or more). After passing through the optical amplifying repeater 14, the main signal lights λ1 to km and the SV light λsv1 are transmitted in the optical fiber transmission line 13a-2. Accordingly, the main signal lights λ1 to λm and the SV light λsv1 cause Reyleigh scattering within the optical fiber transmission line 13a-2. After causing the Reyleigh scattering, part of the main signal lights λ1 to λm and SV light λsv1 is propagated back through the optical fiber transmission line 13a-2 and returns to the optical amplifying repeater 14. Then the scattering light is transmitted to the opposite transmission line side via the optical coupler 15a-2 and the optical bypass 18, and inputted to the FBG 19b-1 via the optical coupler 15b-1. Here, only the SV light λsv1 is reflected. The reflected SV light λsv1 is returned to the originating optical line terminating equipment via the optical coupler 15b-1, the optical amplifying repeater 16b and the optical coupler 15b-2. The optical line terminating equipment supervises the state of the optical fiber transmission line 13a-2 by receiving the SV light λsv1.

Similarly, as shown in FIG. 12, the SV light λsv2 is transmitted from the optical line terminating equipment together with main signal lights λ1 to λm and inputted to the optical amplifying repeater 14. Part of the inputted main signal lights λ1 to λm and SV light λsv2 is branched by the optical coupler 15a-2 and inputted to the FBG 19a-2. Here, only the SV light λsv2 is reflected. The reflected SV light λsv2 is transmitted to the opposite transmission line via the optical coupler 15a-2 and the optical bypass 18. Then the SV light λsv2 passes through the optical coupler 15b-1 and is transmitted in the optical fiber transmission line 13b-l. Accordingly, part of the SV light λsv2 causes Reyleigh scattering. After causing the Reyleigh scattering, part of the SV light λsv2 is propagated back through the optical fiber transmission line 13b-1 and is returned to the optical amplifying repeater 14. Then the SV light λsv2 is returned to the originating optical line terminating equipment via the optical amplifying repeater 14. The optical line terminating equipment supervises the state of the optical fiber transmission line 13b-1 by receiving the SV light λsv2.

In this way, the proposition allows for supervising of both the up-streaming/down-streaming transmission lines from one optical line terminating equipment in either side.

However, the proposition described above has the following problem. As shown in FIG. 13, there exists another optical bypass 17 in this proposition. Accordingly, part of the SV light leaks directly to the originating optical line terminating equipment via this bypass. FIG. 14A illustrates how the back scattering light caused by the SV light shown in FIG. 11 or 12 is observed in the optical line terminating equipment. FIG. 14B illustrates how the SV light directly leaking, shown in FIG. 13, is observed in the optical line terminating equipment. FIG. 14C illustrates how a combination of both the lights is observed in the optical line terminating equipment. As shown in the drawings, in addition to the SV light returned by backward-scattering from the optical fiber transmission line to be supervised, the SV light simply returned is simultaneously received. The optical intensity of the SV light returned by shortcut transmission is much higher than that of the back scattering light. Accordingly, a faint back scattering light cannot be measured while the SV light returned by shortcut transmission is received. In addition, influenced by such high intensity, any accurate measurement is impossible for a while thereafter. To supervise an optical fiber transmission line, loss characteristics with respect to the distance direction of a transmission line must be accurately measured. In the above proposition, however, there exists an area (a dead zone) where the information cannot be accurately measured as described above. Furthermore, this phenomenon occurs in the optical amplifying repeaters of each stage. Consequently, the supervising method described above has a problem of being short of accuracy.

### SUMMARY OF THE INVENTION

An exemplary feature of the present invention is to provide a supervising system, a supervising apparatus and a supervising method allowing for supervising accurately both optical transmission lines from either side of the optical transmission lines disposed opposite each other.

A supervising system according to the present invention, for supervising optical transmission lines disposed opposite each other, includes a first optical transmission line, a second optical transmission line disposed opposite the first optical transmission line, a first supervisory light transfer unit, a second supervisory light transfer unit, a first supervisory light receiving unit, and a second supervisory light receiving unit. The first optical transmission line transmits a signal light, a first supervisory light having a different wavelength from that of the signal light, and a second supervisory light having a different wavelength from those of the signal light and the first supervisory light. The first supervisory light transfer unit cuts off the signal light and the second supervisory light from among lights returned while transmitted in the first optical transmission line, and transfers the first supervisory light transmitted, to the second optical transmission line. The second supervisory light transfer unit cuts off the signal light and the first supervisory light from among lights transmitted in the first optical transmission line, and transfers the second supervisory light transmitted, to the second optical transmission line. The first supervisory light receiving unit receives the first supervisory light transferred by the first supervisory light transfer unit and returned through the second optical transmission line. The second supervisory light receiving unit receives the second supervisory light transferred by the second supervisory light transfer unit and returned while transmitted in the second optical transmission line.

A supervising apparatus according to the present invention, for supervising optical transmission lines disposed opposite each other, includes a first optical transmission line, a second optical transmission line disposed opposite the first optical transmission line, a first supervisory light transfer unit, and a second supervisory light transferunit. The first optical transmission line transmits a signal light, a first supervisory light having a different wavelength from that of the signal light, and a second supervisory light having a different wavelength from those of the signal light and the first supervisory light. The first supervisory light transfer unit cuts off the signal light and the second supervisory light from among lights returned while transmitted in the first optical transmission line, and transfers the first supervisory light transmitted, to the second optical transmission line. The second supervisory light transfer unit cuts off the signal light and the first supervisory light from among lights transmitted in the first optical transmission line, and transfers the second supervisory light transmitted, to the second optical transmission line.

A supervising method according the present invention, for supervising optical transmission lines disposed opposite each other, includes transmitting in addition to a signal light, a first supervisory light having a different wavelength from that of the signal light and a second supervisory light having a different wavelength from those of the signal light and the first supervisory light to a first optical transmission line; cutting off the signal light and the second supervisory light from among lights returned while transmitted in the first optical transmission line; transferring the first supervisory light transmitted, from the first optical transmission line to the second optical transmission line; receiving and supervising the first supervisory light transferred to the second optical transmission line, cutting off the signal light and the first supervisory light from among lights transmitted in the first optical transmission line; transferring the second supervisory light transmitted, from the first optical transmission line to the second optical transmission line; and receiving and supervising the second supervisory light returned while transmitted in the second optical transmission line.

As described above, the supervising system, the supervising apparatus and the supervising method according to the present invention has an effect of allowing for supervising accurately both optical transmission lines from either side of the optical transmission lines disposed opposite each other.

### BRIEF DESCRIPTION OF THE DRAWINGS

The exemplary aspects, features and advantages of the present invention will become more apparent from the following detailed description when taken in conjunction with the accompanying drawings wherein:

FIG. 1 is a view showing an example of configuration of an optical amplifying repeater according to a first exemplary embodiment of the present invention;

FIG. 2 is a view showing an example of transmittance characteristics of an optical filter included in the optical amplifying repeater of FIG. 1;

FIG. 3 is a view showing an example of configuration of an optical transmission system having applied thereto the optical amplifying repeater of FIG. 1;

FIG. 4 is a view showing supervision by supervisory signal light λsv1 in the optical amplifying repeater of FIG. 1;

FIG. 5 is a view showing supervision by supervisory signal light λsv2 in the optical amplifying repeater of FIG. 1;

FIG. 6 is a view showing how the supervisory signal light is observed in the optical amplifying repeater of FIG. 1;

FIG. 7 is a view showing an example of configuration of an optical amplifying repeater according to a second exemplary embodiment of the present invention;

FIG. 8 is a view showing supervision by supervisory signal light in the optical amplifying-repeater of FIG. 7;

FIG. 9 is a view showing a variation of the second exemplary embodiment of the present invention;

FIG. 10 is a view showing a configuration of an optical amplifying repeater-relating to the present invention;

FIG. 11 is a view showing supervision by supervisory signal light λsv1 in the optical amplifying repeater of FIG. 10;

FIG. 12 is a view showing supervision by supervisory signal light λsv2 in the optical amplifying repeater of FIG. 10;

FIG. 13 is a view showing leakage of the supervisory signal lights λsv1 and λsv2 in the optical amplifying repeater of FIG. 10;

FIG. 14A is a view showing the intensity of back scattering light by supervisory signal light in the optical amplifying repeater of FIG. 10;

FIG. 14B is a view showing the intensity of supervisory signal light transmitted via a shortcut path in the optical amplifying repeater of FIG. 10; and

FIG. 14C is a view showing how a combination of the supervisory signal lights of FIGS. 14A and 14B is observed.

### DETAILED DESCRIPTION OF THE EXEMPLARY EMBODIMENTS:

The preferred embodiments for implementing the present invention will be described below in detail with reference to the drawings. The embodiments described below show specific examples for purposes of understanding the present invention, and the scope of the present invention is not limited to the embodiments.

It is noted that “supervising system”, “supervising apparatus” and “optical transmission line” described in claims are represented specifically as “optical transmission system”, “optical amplifying repeater” and “optical fiber transmission line”; “supervisory light transfer unit” is represented specifically as a configuration including appropriately “optical bypass”, “optical filter”, “optical coupler”, “optical circulator” and “optical multiplexing/demultiplexing coupler”; “supervisory light receiving unit” and “supervisory light transmitting unit” are represented specifically as “supervisory light receiver” and “supervisory light transmitter”. However, these devices only represent an example of the present invention, and the claims of the present invention are not limited only to these devices.

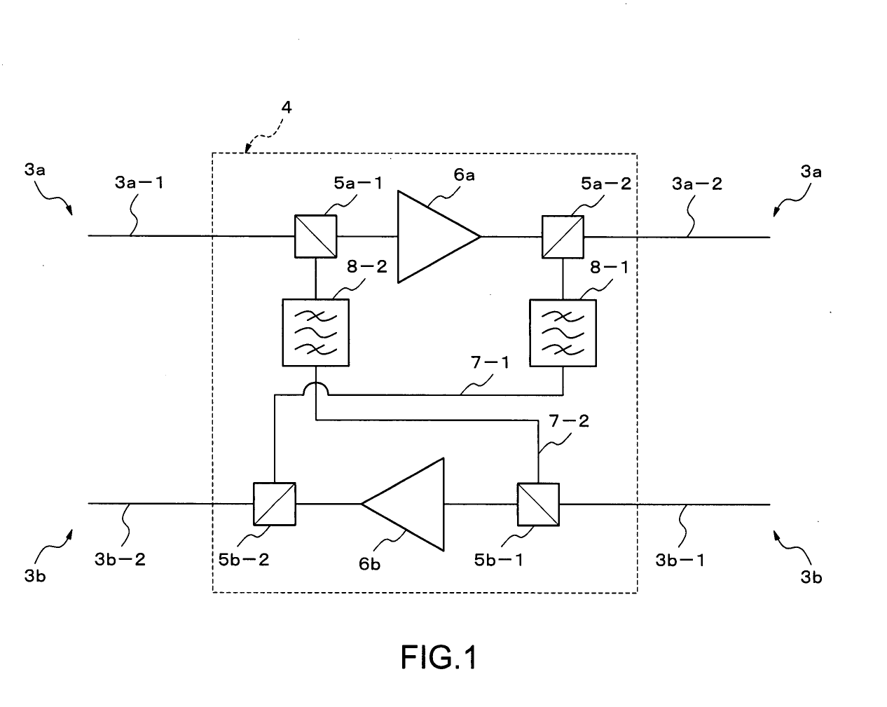

FIG. 1 is a view showing an example of configuration of an optical amplifying repeater according to a first exemplary embodiment of the present invention. Optical fiber transmission lines 3a-1 and 3a-2 are part of down-streaming optical fiber transmission line 3a; optical fiber transmission lines 3b-1 and 3b-2 are part of up-streaming optical fiber transmission line 3b. An optical amplifying repeater 4 includes a down-streaming optical amplifier 6a, an up-streaming optical amplifier 6b, four optical couplers 5a-1, 5a-2, 5b-1 and 5b-2 having an optical branching function, two optical bypasses 7-1 and 7-2 connecting the optical couplers, and two optical-filters 8-1 and 8-2 disposed therebetween.

The down-streaming optical fiber transmission line 3a and up-streaming optical fiber transmission line 3b are connected in a crossed manner via the optical bypasses 7-1 and 7-2. Specifically, the input-side down-streaming optical fiber transmission line 3a-1 and the input-side up-streaming optical fiber transmission line 3b-1 are connected to each other via the optical coupler 5a-1, the optical bypass 7-2, the optical filter 8-2 and the optical coupler 5b-1. The output-side down-streaming optical fiber transmission line 3a-2 and the output-side up-streaming optical fiber transmission line 3b-2 are connected to each other via the optical coupler 5a-2, the optical bypass 7-1, the optical filter 8-1 and the optical coupler 5b-2. An optical amplifier 6a is installed between the optical couplers 5a-1 and 5a-2; an optical amplifier 6b is installed between the optical couplers 5b-l and 5b-2.

In the down-streaming optical fiber transmission line 3a side, the input-side optical coupler 5a-1 branches light supplied from the input-side optical fiber transmission line 3a-1 and outputs one part of the light to the optical filter 8-2 and the other to the optical amplifier 6a. The optical amplifier 6a amplifies light from the input-side optical coupler 5a-l and outputs it to the output-side optical coupler 5a-2. The output-side optical coupler 5a-2 receives the light from the optical amplifier 6a and outputs it to the optical fiber transmission line 3a-2. Also, the output-side optical coupler 5a-2 branches light returned from the optical fiber transmission line 3a-2 and outputs one part of the light to the optical filter 8-1.

Similarly, in the up-streaming optical fiber transmission line 3b side, the input-side optical coupler 5b-1 branches light supplied from the-input-side optical fiber transmission line 3b-1 and outputs one part of the light to the optical filter 8-2 and the other to the optical amplifier 6b. The optical amplifier 6b amplifies light from the input-side optical coupler 5b-1 and outputs it to the output-side optical coupler 5b-2. The output-side optical coupler 5b-2 receives the light from the optical amplifier 6b, outputs it to the optical fiber transmission line 3b-2 and combines it with light supplied from the optical bypass 7-1 to output the resultant light to the optical fiber transmission line 3b-2.

The optical bypass 7-1, connecting the optical couplers 5a-2 and 5b-2, has included therebetween the optical filter 8-1. Another optical bypass 7-2, connecting the optical couplers 5a-l and 5b-1, has included therebetween the optical filter 8-2. The optical filters 8-1 and 8-2 each have a specific wavelength band as transmittance band.

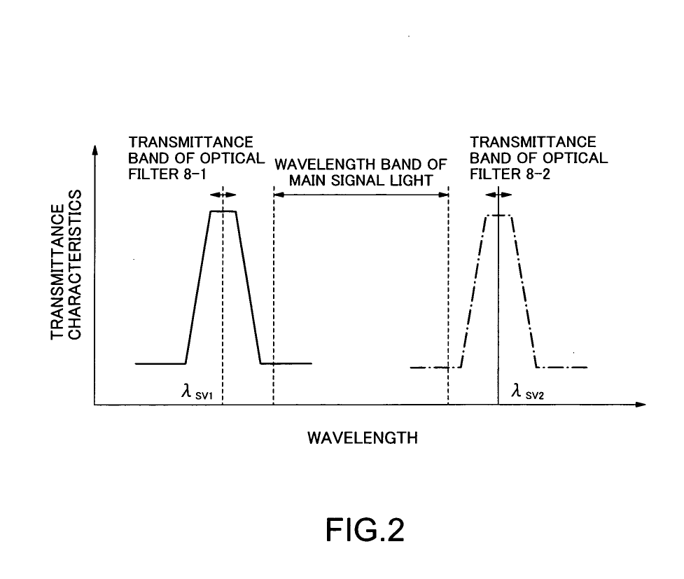

FIG. 2 shows an example of transmittance characteristics of the optical filters 8-1 and 8-2, and the relationship between the wavelengths of supervisory signal light (hereinafter referred to as SV light) λsv1, main signal lights λ1 to λm (m being an integer number of 2 or more) and SV light λsv2. The characteristic of the optical filter 8-1 transmits the SV light's wavelength λsv1 and cuts off significantly (equal to or more than 20 dB, for example) the SV light's wavelength λsv2 and signal light's wavelengths λ1 to λm. On the other hand, the characteristic of the optical filter 8-2 transmits the SV light's wavelength λsv2 and cuts off significantly (equal to or more than 20 dB, for example) the SV light's wavelength λsv1 and signal light's wavelengths λ1 to λm. As the optical filter, an optical band-pass filter (OBPF) with a multilayer film or the like can be used. A low-pass filter may be used as the optical filter 8-1, and a high-pass filter may be used as the optical filter 8-2.

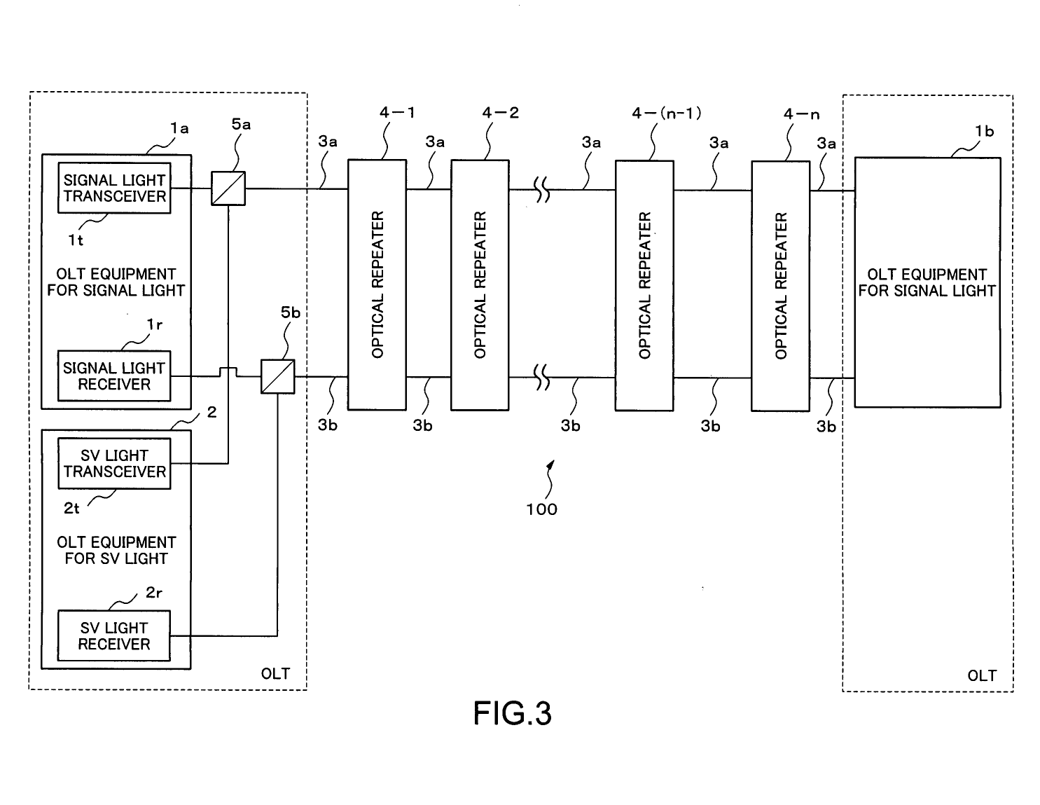

FIG. 3 shows an example of an optical transmission system having applied thereto an optical amplifying repeater according to the present exemplary embodiment. The optical transmission system 100 includes down-streaming/up-streaming optical fiber transmission lines 3a and 3b disposed opposite each other, optical line terminating equipment for transmitting and receiving wavelength-division-multiplexed signal light (hereinafter referred to as OLT equipment for signal light) 1a and 1b disposed in both ends of the transmission line, and optical amplifying repeaters 4-1 to 4-n (n being an integer of 2 or more) connected in multiple stages between the terminating equipment. In the down-streaming optical fiber transmission line 3a and the up-streaming optical fiber transmission line 3b, optical couplers 5a and 5b are provided, respectively. To the optical couplers, there is connected an optical line terminating equipment for transmitting and receiving supervising signal light (hereinafter referred to as OLT equipment for SV light) 2. In the OLT equipment for signal light 1a, main signal light is transmitted from a signal light transceiver 1t toward the down-streaming optical fiber transmission line 3a, and the main signal light is received from the up-streaming optical fiber transmission line 3b by a signal light receiver 1r. To perform wavelength division multiplex/demultiplex, the signal light transceiver 1t and the signal light receiver 1r are provided with a wavelength multiplexer and a wavelength demultiplexer according to need, respectively. The OLT equipment for SV light 2 is provided with a SV light transceiver 2t. The SV light transceiver 2t outputs SV lights λsv1 and λsv2 to the down-streaming optical fiber transmission line 3a via the optical coupler 5a. The OLT equipment for SV light 2 is also provided with a SV light receiver 2r. The SV light receiver 2r receives SV lights λsv1 and λsv2 outputted from the up-streaming optical fiber transmission line 3b via the optical coupler 5b. The transceiver and receiver are also provided with a wavelength multiplexer and a wavelength demultiplexer according to need, respectively.

An OTDR (Optical Time Domain Reflectometer) technique maybe used to transmit and receive SV lights. In recent years, the OTDR technique is widely used as a technique for detecting a failure point of optical transmission line. According to this technique, firstly a short optical pulse for supervision is supplied to the optical fiber to be examined. Subsequently this optical pulse causes Reyleigh scattering at each transmission position within the optical fiber to be examined. Consequently, back scattering lights are generated. In the OTDR technique, the back scattering lights thus returned are measured relative to time. Accordingly, loss characteristics at each transmission position within the optical fiber can be detected with high resolution of distance. Thus SV lights λsv1 and λsv2 transmitted from the OLT equipment for SV light 2 to the optical transmission line 3a via the optical coupler 5a may be a pulse light. On the other hand, the SV lights λsv1 and λsv2 received from the optical transmission line 3b via the optical coupler 5b are a back scattering light from the optical fiber transmission lines 3a and 3b.

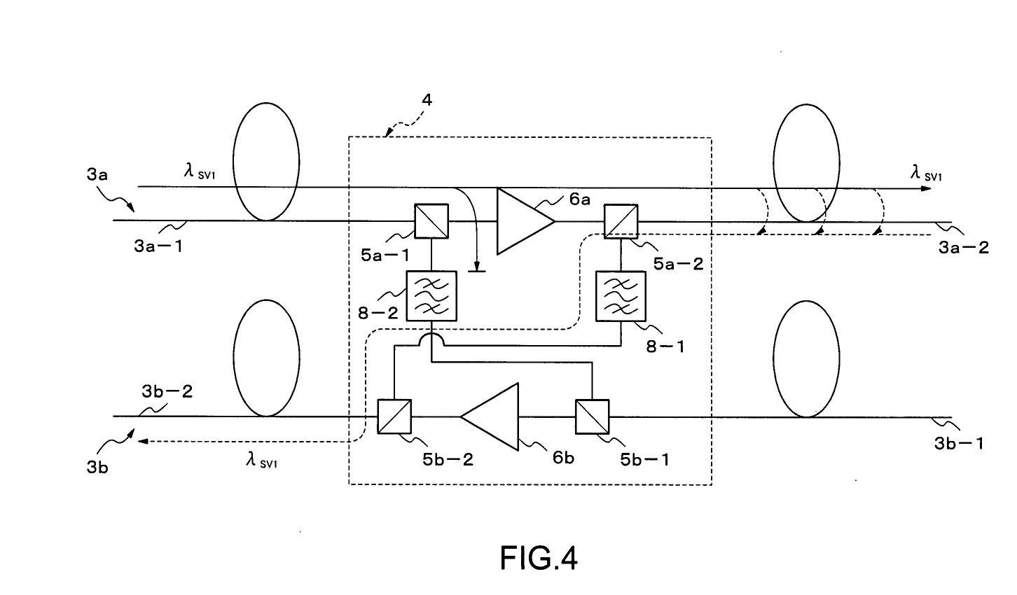

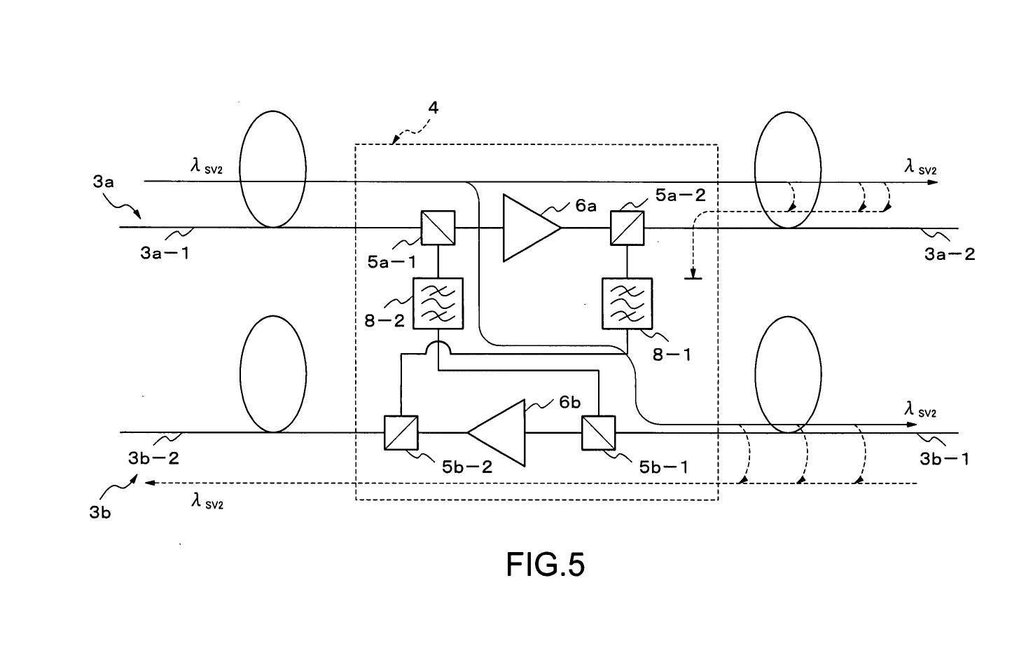

The operation of the first exemplary embodiment of the present invention will now be described with reference to FIGS. 3, 4 and 5. FIG. 4 shows sup rvising of the down-streaming optical fiber transmission line 3a. Specifically, the operation of supervising the down-streaming optical fiber transmission line 3a by SV light λsv1 is illustrated. Similarly, FIG. 5 shows supervising of the up-streaming optical fiber transmission line 3b. Specifically, the operation of supervising the up-streaming optical fiber transmission line 3b by SV light λsv2 is illustrated.

Referring to FIG. 3, firstly main signal lights λ1 to λm are outputted from the OLT equipment for signal light 1a, and SV lights λsv1 and λsv2 are outputted from the OLT equipment for SV light 2. These signal lights are multiplexed by the optical coupler 5a. The multiplexed light is transmitted through the optical fiber transmission line 3a and inputted to the optical amplifying repeaters 4-1 to 4-n. The supervising operation in any one of the optical amplifying repeaters 4-1 to 4-n will be described below with reference to FIG. 4.

Referring to FIG. 4, firstly signal lights λ1 and λ2 and SV lights λsv1 and λsv2 (hereinafter referred to as a multiplexed light) inputted from the optical fiber transmission line 3a-1 to the optical amplifying repeater 4 are branched by the optical coupler 5a-1. One part of the branched light is outputted to the optical filter 8-2, and the other to the optical amplifier 6a. The multiplexed light outputted to the optical amplifier 6a is amplified by the optical amplifier 6a and then outputted to an optical coupler 5a-2. Subsequently, the multiplexed light is outputted to the optical fiber transmission line 3a-2 via the optical coupler 5a-2. The multiplexed light transmitted in the optical fiber transmission line 3a-2 produces return lights caused by Reyleigh scattering or by Fresnel reflection at a connection point etc., at each transmission position within the optical fiber transmission line 3a-2. The return lights are propagated back through the optical fiber transmission line 3a-2 and are returned to the optical amplifying repeater 4. Then the return lights are branched by the optical coupler 5a-2. One part of the branched light is outputted to an optical filter 8-1 via an optical bypass 7-1, and the other to the optical amplifying repeater 6a. An optical isolator etc. included in the optical amplifier 6a prevents the other part outputted to the optical amplifying repeater 6a from being inputted. From among the multiplexed light outputted to the optical filter 8-1, the main signal lights λ1 to λm and SV light λsv2 are cut off. Only the SV light λsv1 is outputted to an optical coupler 5b-2 via the optical bypass 7-1. Subsequently, after inputted to the optical coupler 5b-2, the SV light λsv1 is sent to an opposite optical fiber transmission line 3b-2. Referring to FIG. 3, finally the SV light λsv1 is returned from the optical fiber transmission line 3b to the OLT equipment for SV light 2 via the optical coupler 5b. In the OLT equipment for SV light 2, the intensity of the SV light λsv1 thus returned is measured, whereby the state of the down-streaming optical fiber transmission line 3a can be detected. In addition, the presence or absence of failure within the optical amplifying repeaters connected to the down-streaming optical fiber transmission line 3a-2 and subsequent lines can also be detected.

Referring to FIG. 5, from among the multiplexed light outputted to the optical filter 8-2, the main signal lights λ1 to λm and the SV light λsv1 are cut off by the optical filter 8-2 (through which only a wavelength of λ2 is transmitted) like operation in FIG. 4. Only the SV light λsv2 is outputted to an optical coupler 5b-1 via an optical bypass 7-2. Then the SV light λsv2 is sent to an opposite optical fiber transmission line 3b-1. The SV light λsv2 transmitted in the optical fiber transmission line 3b-l produces return lights caused by Reyleigh scattering or by Fresnel reflection at a connection point etc., at each transmission position within the optical fiber transmission line 3b-1. The return lights are propagated back through the optical fiber transmission line 3b-1 and is returned to the optical amplifying repeater 4. The return lights are outputted to the optical amplifier 6b via the optical coupler 5b-1.

The SV light λsv2 outputted to the optical amplifier 6b is amplified and then outputted to an optical fiber transmission line 3b-2 via the optical coupler 5b-2. Referring to FIG. 3, finally the SV light λsv2 is returned from the optical fiber transmission line 3b to the OLT equipment for SV light 2 via the optical coupler 5b. In the OLT equipment for SV light 2, the intensity of the SV light λsv2 thus returned is measured, whereby the state of the up-streaming optical fiber transmission line 3b can be detected. In addition, the presence or absence of failure within the optical amplifying repeaters connected to the up-streaming optical fiber transmission line 3b-1 and precedent lines can also be detected.

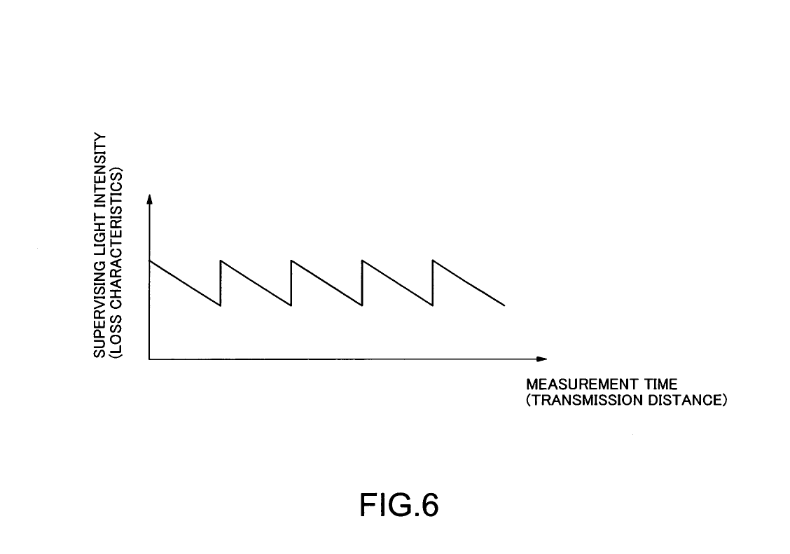

FIG. 6 shows an example in which the intensity of SV light is measured in the OLT equipment for SV light 2. From this measurement result, an abnormal intensity value etc. can be detected and supervised.

The above described supervising of an optical fiber transmission line can be performed from either side by any one of the optical line terminal (reference characters 1a side and 1b side in FIG. 3) disposed on both sides of the optical transmission system. However, when the optical fiber transmission line is supervised from the optical line terminal of 1b side, the optical fiber transmission line 3a side is supervised by SV light λsv2, and the optical fiber transmission line 3b side is supervised by SV light λsv1. Also, the SV lights λsv1 and λsv2 are transmitted to the optical fiber transmission line 3b and received from the optical fiber transmission line 3a. Further, to enhance the supervision, both the optical fiber transmission lines may be supervised by the respective optical line terminal on both sides.

As described above, the present exemplary embodiment has the following effect.

With the configuration described above, the present exemplary embodiment has an effect of allowing for supervising both down-streaming and up-streaming optical fiber transmission lines by an OLT equipment for SV light disposed in either side of optical fiber transmission lines disposed opposite each other. Also, since it is sufficient to arrange an OLT equipment for SV light in either side of the optical transmission system, the present exemplary embodiment has an effect of allowing for system cost reduction and implementation of a simpler system configuration. Also, the optical filter disposed on the optical bypass prevents main signal lights from being transmitted, so the main signal lights do not leak to the opposite optical transmission line. Accordingly, the present exemplary embodiment has an effect in that the signal characteristics of main signal lights are not deteriorated.

When OLT equipment for SV light is arranged in both sides of the optical transmission system, it is possible to supervise both the-down-streaming and up-streaming optical transmission lines from both sides. Accordingly, by comparing data from both the OLT equipment for SV light, it is possible to maintain high accuracy and reliability of the measurement result.

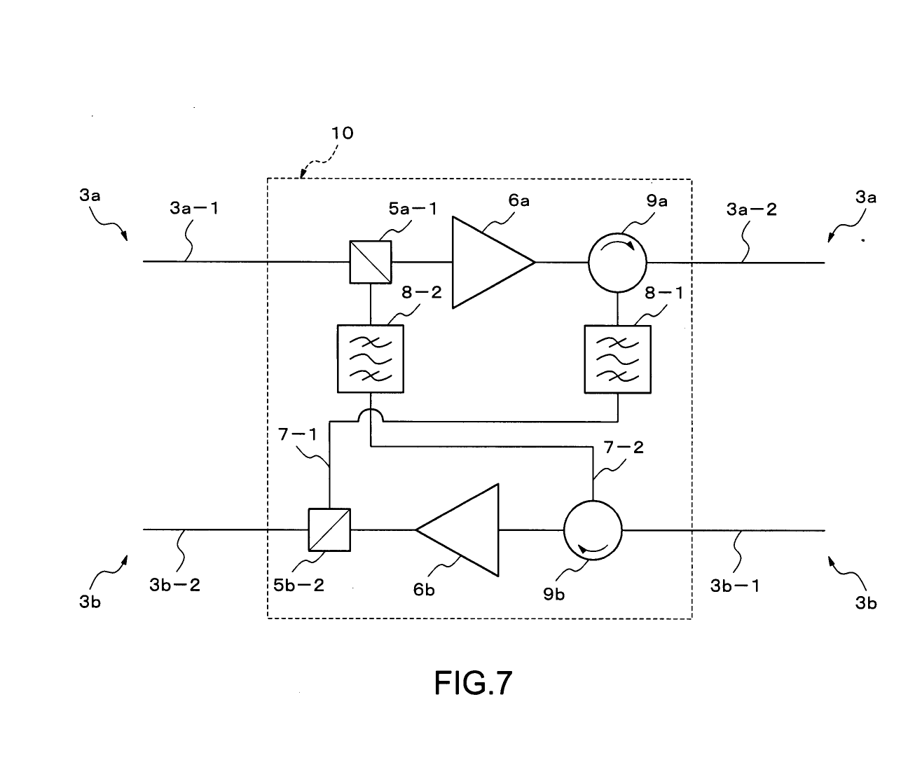

FIG. 7 shows a second exemplary embodiment according to the present invention. A description will be given below with reference to FIG. 7. In FIG. 7, the same reference characters are applied to parts corresponding to FIG. 1, and an explanation thereof is omitted. According to the present exemplary embodiment, the optical coupler 5a-2 used in the first exemplary embodiment shown in FIG. 1 is replaced with an optical circulator 9a, and the optical coupler 5b-1 with an optical circulator 9b. The optical circulators 9a and 9b are provided with at least three terminals. The optical circulator 9a has a function of sending light from an optical amplifier 6a to an optical fiber transmission line 3a-2 and sending light from the optical fiber transmission line 3a-2 to an optical bypass 7-1. The optical circulator 9b has a function of sending light from an optical bypass 7-2 to an optical fiber transmission line 3b-1 and sending light from the optical fiber transmission line 3b-l to an optical amplifier 6b. In this way, the optical circulators do not branch light like an optical coupler, so they have the advantage of being capable of transferring more efficiently signal lights and SV lights without performing unintended branching.

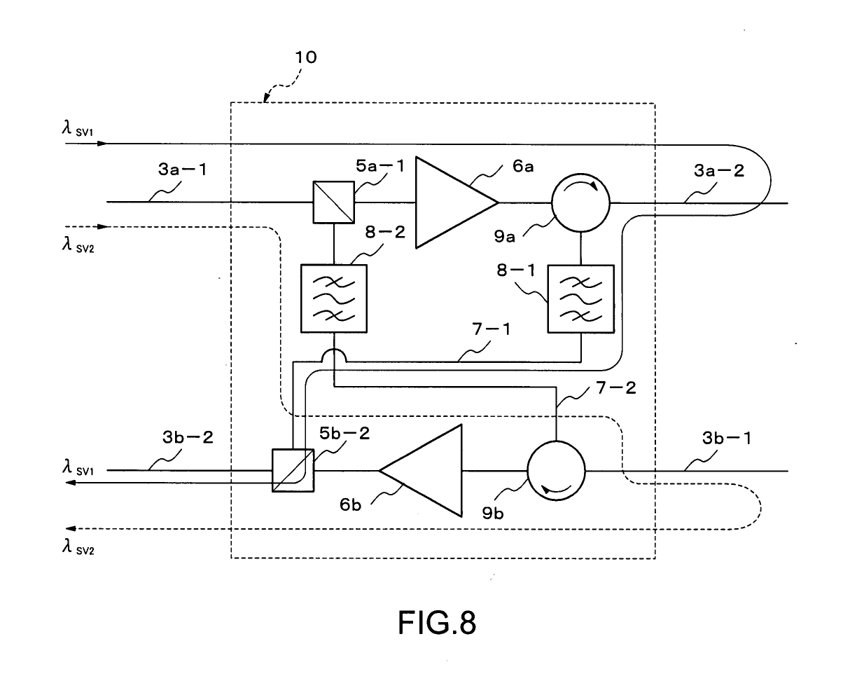

The second exemplary embodiment according to the present invention will now be described with reference to FIG. 8. Main signal light and SV lights λsv1 and λsv2 supplied from an optical fiber transmission line 3a-l to an optical amplifying repeater 10 are branched to the optical amplifier 6a and the optical bypass 7-2 by an optical coupler 5a-l. The main signal lights and SV lights branched to the optical amplifier 6a are amplified by the optical amplifier 6a and then outputted to an optical circulator 9a. The optical circulator 9a outputs the lights outputted from the optical amplifier 6a to an optical fiber transmission line 3a-2. The outputted lights cause Reyleigh scattering, Fresnel reflection or the like while transmitted within the optical fiber transmission line 3a-2. Accordingly, return lights are generated. Then the return lights are propagated back within the optical fiber transmission line 3a-2 and are returned to the optical amplifying repeater 10. Then the return lights are outputted to an optical bypass 7-1 via the optical circulator 9a. Except for the SV light λsv1, the return lights are cut off by an optical filter 8-1. Finally the SV light λsv1 is outputted to an opposite optical fiber transmission line 3b-2 via the optical coupler 5b-2 and returned to the originating OLT equipment for SV light. In this way, the down-streaming optical fiber transmission line 3a side is supervised by the SV light λsv1.

Similarly, except for the SV light λsv2, the main signal lights and SV lights branched to the optical bypass 7-2 by the optical coupler 5a-l are cut off by an optical filter 8-2. The SV light λsv2 passes through the optical bypass 7-2 and is outputted to an opposite optical fiber transmission line 3b-1 via an optical circulator 9b. While the SV light λsv1 is transmitted within the optical fiber transmission line 3b-1, return lights are generated. The return lights are propagated back within the optical fiber transmission line 3b-1 and are returned to the optical amplifying repeater 4. Then the return lights are outputted to an optical amplifier 6b via the optical circulator 9b. Finally the return lights are amplified by the optical amplifier 6b and then returned to the originating OLT equipment for SV light via the optical coupler 5b-2 and optical fiber transmission line 3b-2. In this way, the up-streaming optical fiber transmission line 3b side is supervised by the SV light λsv2.

The second exemplary embodiment has an effect similar to that of the first exemplary embodiment. In addition, instead of light branching couplers, the optical circulators 9a and 9b are used in the second exemplary embodiment. Consequently, the SV lights can be transferred more efficiently. Also, the second exemplary embodiment has an effect of being capable of reducing optical loss with respect to SV light relative to the first exemplary embodiment, and further has an effect of reducing optical loss with respect to signal light.

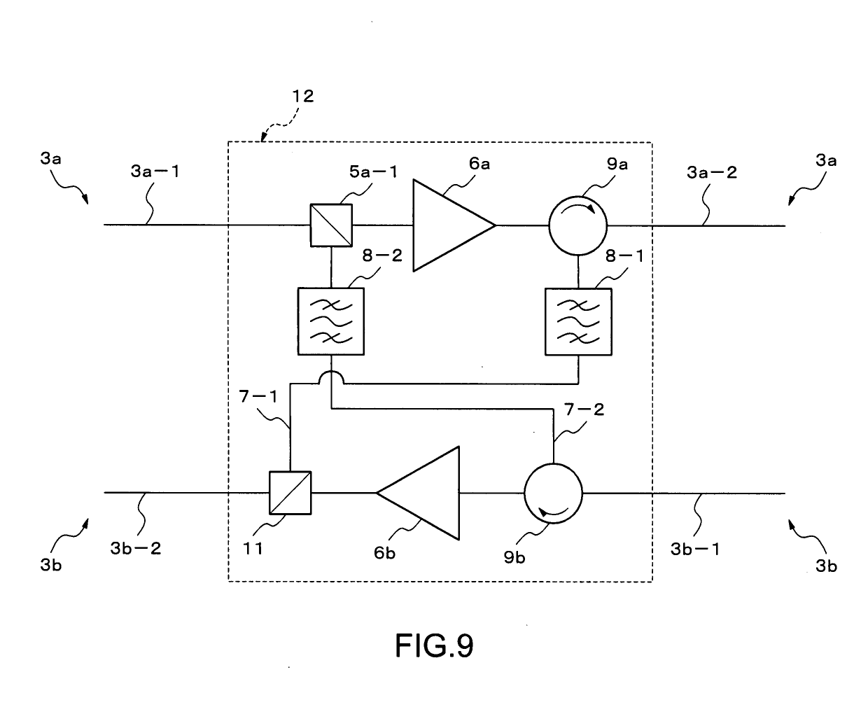

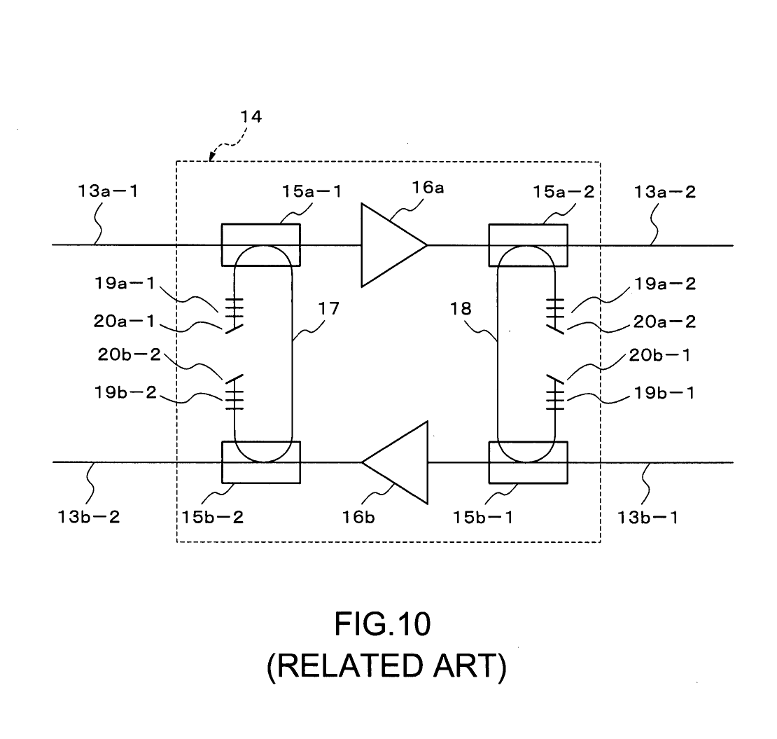

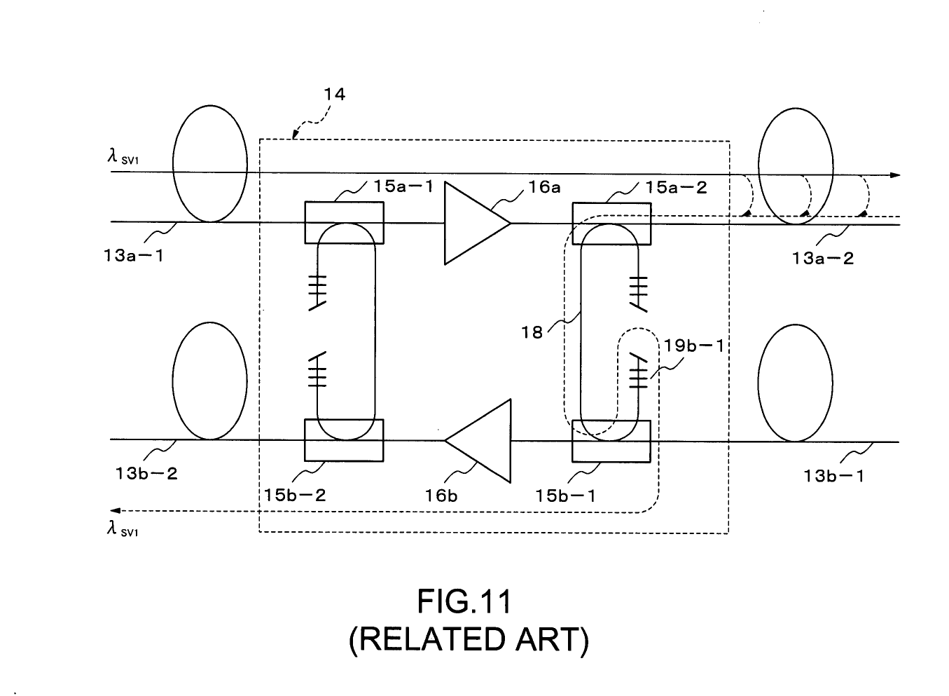

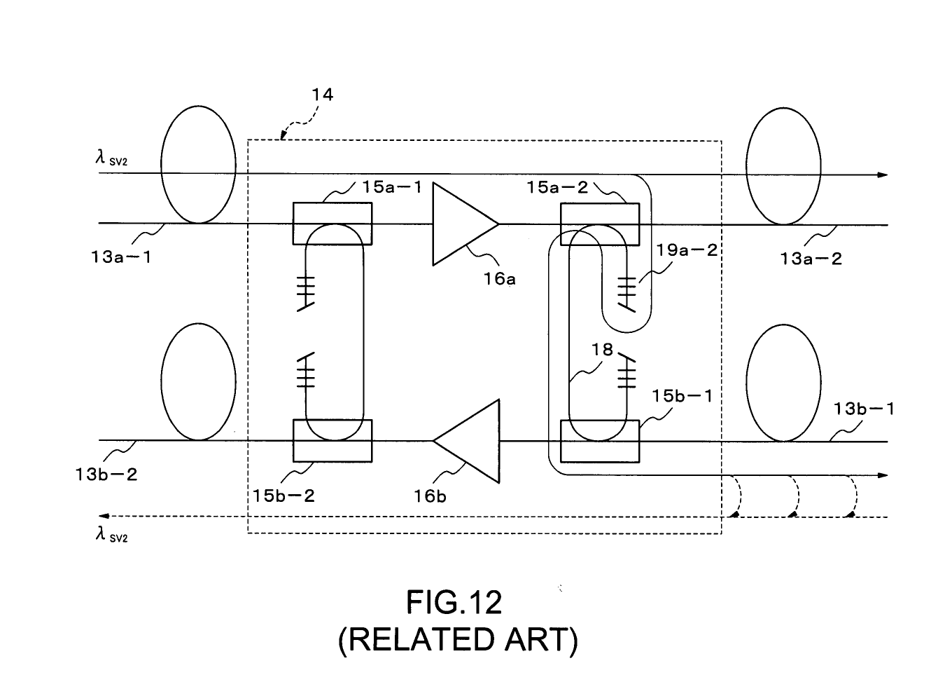

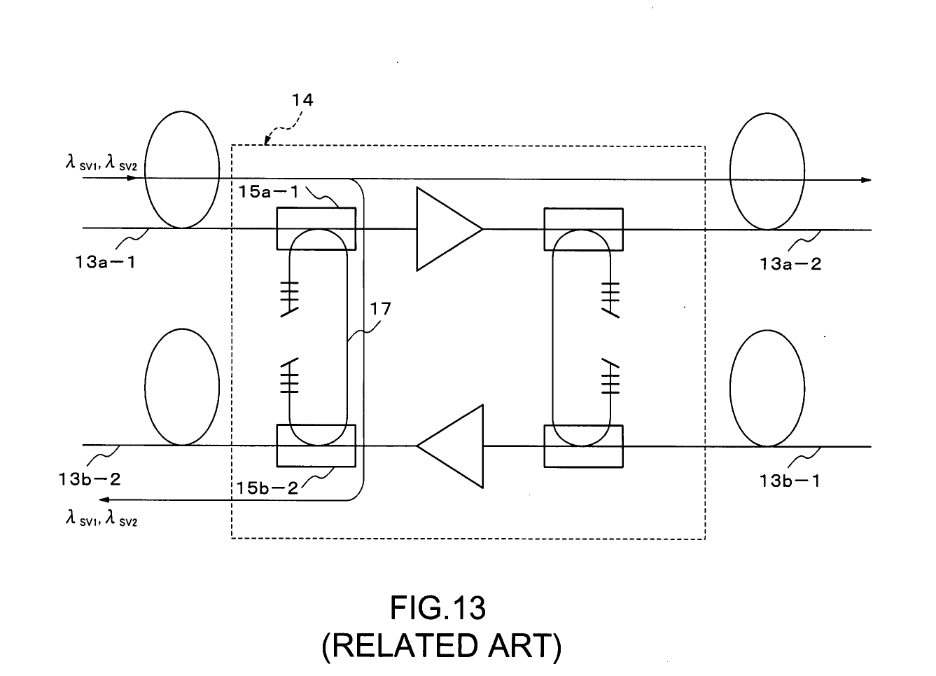

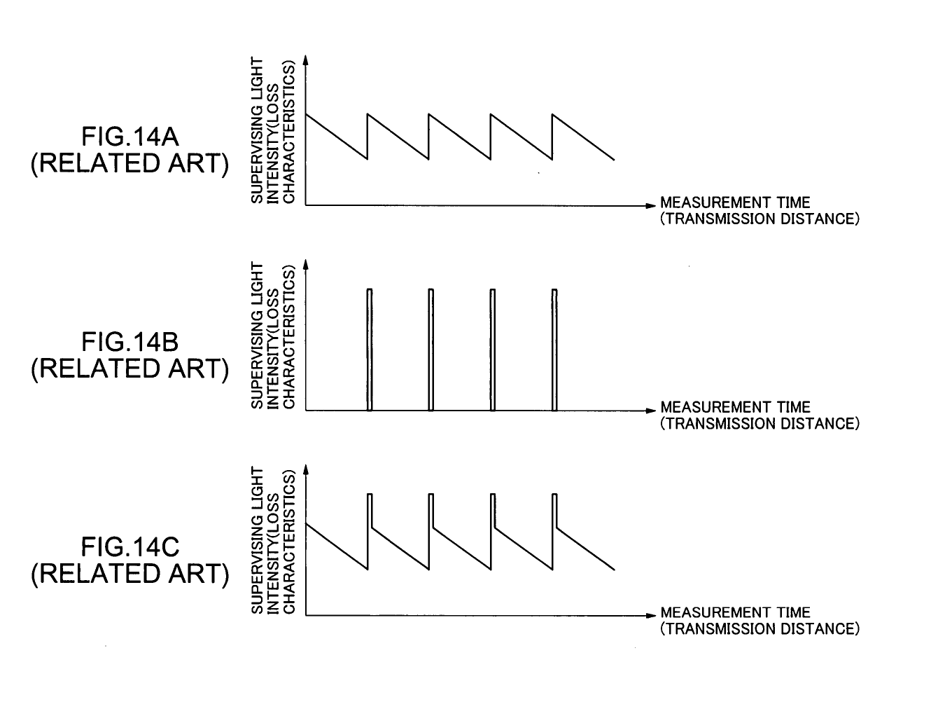

Further, in the configuration shown in FIG. 8, the optical coupler 5b-2 may be replaced with an optical multiplexing/demultiplexing coupler. FIG. 9 shows an exemplary optical amplifying repeater 12 using an optical multiplexing/demultiplexing coupler 11. The optical multiplexing/demultiplexing coupler 11 has a function of multiplexing the SV light λsv1 supplied from the optical bypass 7-1 side and the main signal lights and SV light λsv2 supplied from the optical fiber transmission line 3b-1 side. Accordingly, it is possible to reduce optical loss when the SV light λsv1 is outputted from the optical bypass 7-1 to the optical fiber transmission line 3b-2 via the optical multiplexing/demultiplexing coupler 11. Furthermore, it is also possible to reduce optical loss when the signal lights in the up-streaming optical fiber transmission line 3b side pass through the optical multiplexing/demultiplexing coupler 11.

According to the present invention, the main signal light is not limited to wavelength-division-multiplexed signal light, and the signal light may have a single wavelength.

While the present invention has been described in connection with certain exemplary embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

Further, the inventor's intent is to retain all equivalents of the claimed invention even if the claims are amended later during prosecution.

What is claimed is:

1. A supervising system for supervising optical transmission lines disposed opposite each other, comprising:
a first optical transmission line which transmits a signal light, a first supervisory light having a different wavelength from that of the signal light, and a second supervisory light having a different wavelength from those of the signal light and the first supervisory light;
a second optical transmission line disposed opposite the first optical transmission line;
a first supervisory light transfer unit which cuts off the signal light and the second supervisory light from among lights returned while transmitted in the first optical transmission line, and transfers the first supervisory light transmitted, to the second optical transmission line;
a second supervisory light transfer unit which cuts off the signal light and the first supervisory light from among lights transmitted in the first optical transmission line, and transfers the second supervisory light transmitted, to the second optical transmission line;
a first supervisory light receiving unit which receives the first supervisory light transferred by the first supervisory light transfer unit and returned through the second optical transmission line; and
a second supervisory light receiving unit which receives the second supervisory light transferred by the second supervisory light transfer unit and returned while transmitted in the second optical transmission line.

2. The supervising system according to claim 1, wherein:
the first supervisory light transfer unit comprises a first optical bypass connecting the first optical transmission line and the second optical transmission line; and
the second supervisory light transfer unit comprises a second optical bypass connecting the first optical transmission line and the second optical transmission line.

3. The supervising system according to claim 2, wherein the first optical bypass and the second optical bypass each comprise an optical filter which selectively cuts off/transmits light.

4. The supervising system according to claim 2, wherein the first supervisory light transfer unit and the second supervisory light transfer unit further each comprise an optical coupler.

5. The supervising system according to claim 2, wherein the first supervisory light transfer unit and the second supervisory light transfer unit further each comprise an optical circulator.

6. The supervising system according to claim 2, wherein the first supervisory light transfer unit and the second supervisory light transfer unit further each comprise an optical multiplexing/de multiplexing coupler.

7. The supervising system according to claim 2, wherein the first optical bypass and the second optical bypass cross each other.

8. The supervising system according to claim 1, wherein:
the first supervisory light has a shorter wavelength than that of the signal light; and
the second supervisory light has a longer wavelength than that of the signal light.

9. The supervising system according to claim 8, wherein:
the first supervisory light transfer unit cuts off lights having a longer wavelength than that of the first supervisory light; and
the second supervisory light transfer unit cuts off lights having a shorter wavelength than that of the second supervisory light.

10. The supervising system according to claim 1, wherein:
the lights returned while transmitted in the first optical transmission line result from backscattering on the first optical transmission line; and
the lights returned while transmitted in the second optical transmission line result from backscattering on the second optical transmission line.

11. The supervising system according to claim 1, wherein:
the lights returned while transmitted in the first optical transmission line result from reflection on the first optical transmission line; and
the lights returned while transmitted in the second optical transmission line result from reflection on the second optical transmission line.

12. The supervising system according to claim 1, further comprising a light transmitting unit which transmits each of the signal light, the first supervisory light and the second supervisory light.

13. The supervising system according to claim 12, wherein the light transmitting unit, the first supervisory light receiving unit and the second supervisory light receiving unit are arranged within the same optical line terminal.

14. The supervising system according to claim 1, wherein the first supervisory light and the second supervisory light are transmitted and received by use of an OTDR technique.

15. The supervising system according to claim 1, further comprising: an optical amplifying unit disposed between the first supervisory light transfer unit and the second supervisory light transfer unit on the first optical transmission line; and a light amplifying unit disposed between the first supervisory light transfer unit and the second supervisory light transfer unit on the second optical transmission line.

16. A supervising apparatus for supervising optical transmission lines disposed opposite each other, comprising:
a first optical transmission line which transmits a signal light, a first supervisory light having a different wavelength from that of the signal light, and a second supervisory light having a different wavelength from those of the signal light and the first supervisory light;
a second optical transmission line disposed opposite the first optical transmission line;
a first supervisory light transfer unit which cuts off the signal light and the second supervisory light from among lights returned while transmitted in the first optical transmission line, and transfers the first supervisory light transmitted, to the second optical transmission line; and
a second supervisory light transfer unit which cuts off the signal light and the first supervisory light from among lights transmitted in the first optical transmission line, and transfers the second supervisory light transmitted, to the second optical transmission line.

17. The supervising apparatus according to claim 16, wherein:
the first supervisory light transfer unit comprises a first optical bypass connecting the first optical transmission line and the second optical transmission line; and
the second supervisory light transfer unit comprises a second optical bypass connecting the first optical transmission line and the second optical transmission line.

18. The supervising apparatus according to claim 17, wherein the first optical bypass and the second optical bypass each comprise an optical filter which selectively cuts off/transmits light.

19. The supervising apparatus according to claim 17, wherein the first supervisory light transfer unit and the second supervisory light transfer unit further each comprise an optical coupler.

20. The supervising apparatus according to claim 17, wherein the first supervisory light transfer unit and the second supervisory light transfer unit further each comprise an optical circulator.

21. The supervising apparatus according to claim 17, wherein the first supervisory light transfer unit and the second supervisory light transfer unit further each comprise an optical multiplexing/de multiplexing coupler.

22. The supervising apparatus according to claim 17, wherein the first optical bypass and the second optical bypass cross each other.

23. The supervising apparatus according to claim 16, wherein:
the first supervisory light has a shorter wavelength than that of the signal light; and
the second supervisory light has a longer wavelength than that of the signal light.

24. The supervising apparatus according to claim 23, wherein:
the first supervisory light transfer unit cuts off light having a longer wavelength than that of the first supervisory light; and
the second supervisory light transfer unit cuts off light having a shorter wavelength than that of the second supervisory light.

25. The supervising apparatus according to claim 16, wherein:
the lights returned while transmitted in the first optical transmission line result from backscattering on the first optical transmission line; and
the lights returned while transmitted in the second optical transmission line result from backscattering on the second optical transmission line.

26. The supervising apparatus according to claim 16, wherein:
the lights returned while transmitted in the first optical transmission line result from reflection on the first optical transmission line; and
the lights returned while transmitted in the second optical transmission line result from reflection on the second optical transmission line.

27. The supervising apparatus according to claim 16, wherein the first supervisory light and the second supervisory light are transmitted and received by use of an OTDR technique.

28. The supervising apparatus according to claim 16, further comprising: an optical amplifying unit disposed between the first supervisory light transfer unit and the second supervisory light transfer unit on the first optical transmission line; and a light amplifying unit disposed between the first supervisory light transfer unit and the second supervisory light transfer unit on the second optical transmission line.

29. A supervising apparatus for supervising optical transmission lines disposed opposite each other, comprising:
a first optical transmission line which transmits a signal light, a first supervisory light having a different wavelength from that of the signal light, and a second supervisory light having a different wavelength from those of the signal light and the first supervisory light;
a second optical transmission line disposed opposite the first optical transmission line;
first supervisory light transfer means which cuts off the signal light and the second supervisory light from among lights returned while transmitted in the first optical transmission line, and transfers the first supervisory light transmitted, to the second optical transmission line; and
second supervisory light transfer means which cuts off the signal light and the first supervisory light from among lights transmitted in the first optical transmission line, and transfers the second supervisory light transmitted, to the second optical transmission line.

30. A supervising system with the supervising apparatus according to claim 29, comprising:
light transmitting means which transmits the signal light, the first supervisory light and the second supervisory light to the first optical transmission line;
the supervising apparatus according to claim 29; and
supervisory light receiving means which receives the first supervisory light and the second supervisory light from the second optical transmission line.

31. A supervising method of supervising optical transmission lines disposed opposite each other, comprising the steps of:
transmitting in addition to a signal light, a first supervisory light having a different wavelength from that of the signal light and a second supervisory light having a different wavelength from those of the signal light and the first supervisory light to a first optical transmission line;
cutting off the signal light and the second supervisory light from among lights returned while transmitted in the first optical transmission line;
transferring the first supervisory light transmitted, from the first optical transmission line to the second optical transmission line;
receiving and supervising the first supervisory light transferred to the second optical transmission line;
cutting off the signal light and the first supervisory light from among lights transmitted in the first optical transmission line;
transferring the second supervisory light transmitted, from the first optical transmission line to the second optical transmission line; and
receiving and supervising the second supervisory light returned while transmitted in the second optical transmission line.

32. The supervising method according to claim 31, wherein the first supervisory light has a shorter wavelength than that of the signal light.

33. The supervising method according to claim 31, wherein the second supervisory light has a longer wavelength than that of the signal light.

34. The supervising method according to claim 31, wherein:
the lights returned while transmitted in the first optical transmission line result from backscattering on the first optical transmission line; and
the lights returned while transmitted in the second optical transmission line result from backscattering on the second optical transmission line.

35. The supervising method according to claim 31, wherein:
the lights returned while transmitted in the first optical transmission line result from reflection on the first optical transmission line; and
the lights returned while transmitted in the second optical transmission line result from reflection on the second optical transmission line.

36. The supervising method according to claim 31, further comprising a step of transmitting each of the signal light, the first supervisory light and the second supervisory light.

37. The supervising method according to claim 36, wherein the transmitting and the receiving are performed within the same optical line terminal.

38. The supervising method according to claim 31, wherein the first supervisory light and the second supervisory light are transmitted and received by use of an OTDR technique.

39. The supervising method according to claim 31, further comprising a step of optically amplifying the first supervisory light and the second supervisory light.
